(19) United States
(12) Patent Application Publication
(10) Pub. No.: US 2023/0313932 A1
(43) Pub. Date: Oct. 5, 2023

(54) DEVICE AND METHOD FOR CAPTURING LEAKS FROM A PIPELINE, VALVE OR FLANGE

(71) Applicant: CHEVRON U.S.A. INC., San Ramon, CA (US)

(72) Inventor: Albert Eugene BUTTERFIELD, IV, Novato, CA (US)

(21) Appl. No.: 18/044,162

(22) PCT Filed: Sep. 3, 2021
(86) PCT No.: PCT/US2021/049005

§ 371 Date: Mar. 6, 2023

Related U.S. Application Data
(60) Provisional application No. 63/075,296, filed on Sep. 7, 2020.

(51) Int. Cl. F16L 55/16

(52) U.S. Cl. CPC F16L 55/16

(57) ABSTRACT

A leak capture device, and methods of use, for capturing leaks from a pipeline, or a valve or flange installed in the pipeline, is provided. The device generally comprises a flexible, impermeable, fabric or sheet material, having a sufficient size and shape, and supporting means to form, when installed, a fluid leak containment reservoir pocket below the pipeline, valve, or flange to capture leaked fluid. The device is easily and quickly installed and can be sized and arranged to economically capture leaks from a wide range of pipeline/valve/flange configurations and thereby avoid negative environmental and regulatory impacts and associated costs. The device is easy to use for regular maintenance operations and can be made readily available for installation in emergency or other unscheduled events.

### CROSS REFERENCE TO RELATED APPLICATIONS

This application is the national stage application of International Appl. No. PCT/US2021/049005 (doc. no. T-11194), filed on 3 Sep. 2021, and is related to, and claims the benefit of priority to U.S. Provisional Patent Appl. Ser. No. 63/075,296 filed on 7 Sep. 2020, entitled “DEVICE AND METHOD FOR CAPTURING LEAKS FROM A PIPELINE, VALVE OR FLANGE”, the disclosures of which are herein incorporated in their entirety.

### FIELD OF THE INVENTION

A device and method for capturing leaks from a pipeline, valve, or flange, particularly during maintenance operations.

### BACKGROUND OF THE INVENTION

Petroleum and petrochemical operations and facilities, including storage, processing, and pipeline installations, require transporting, mixing and storing large quantities of oil and chemicals throughout the facilities. Large and complex networks of pipelines, valves, processing units, and storage tanks are needed for such operations, which require significant maintenance, safety, environmental and operational standards to be met. In pipeline operations, for example, the need to avoid spills or leaks arising from accidents or planned maintenance work mandates that protective preventative measures be taken to eliminate or mitigate any such spills or leaks within the facility and into the environment.

Pipelines within such facilities typically contain many valves and flange connections that require periodic maintenance, including removal and replacement of various parts. Frequently such work areas are difficult to isolate and protect against spills or leaks due to the close arrangement of pipes, valves, and other pipeline components. Typical spill containment devices often do not work effectively in such situations since they either do not closely contain the leaked fluid or since they do not allow for maintenance and other work to be performed while also providing continuous protection against such spills or leaks. It can therefore be difficult to contain pipeline fluids while conducting routine maintenance or other work on pipelines, valves and other pipeline components. Accordingly, a need exists for an effective, economical, and flexibly implemented device that can be easily and quickly installed to contain spills and leaks from pipelines, and associated components of the pipeline, while also allowing for maintenance and other work to be performed while such spills or leaks are contained.

### BRIEF DESCRIPTION OF THE DRAWINGS

FIG. 1 shows a plan view of an illustrative embodiment of the leak capture device with components of the device numerically identified.

FIG. 2 provides a photo image of the leak capture device in an uninstalled and open, laid flat arrangement.

FIG. 3 shows an installed view of the leak capture device surrounding a valve installed within a pipeline.

FIG. 4 shows an installed view of the leak capture device surrounding a valve installed within a pipeline.

FIG. 5 shows an installed view of the leak capture device surrounding a valve installed within a pipeline.

### SUMMARY OF THE INVENTION

This invention relates to a leak capture device, and methods of use, for capturing leaks from a pipeline, or a valve or flange installed in the pipeline. The device generally comprises a flexible, impermeable, fabric or sheet material, having a sufficient size and shape, and supporting means to form, when installed, a fluid leak containment reservoir pocket below the pipeline, valve, or flange to capture leaked fluid. The device is easily and quickly installed and can be sized and arranged to economically capture leaks from a wide range of pipeline/valve/flange configurations and thereby avoid negative environmental and regulatory impacts and associated costs. The device is easy to use for regular maintenance operations and can be made readily available for installation in emergency or other unscheduled events.

In one aspect, the leak capture device is formed from a flexible fabric or sheet material and comprises a flexible, impermeable, fabric or sheet material, having a sufficient size and shape, and comprising supporting means to form, when installed, a fluid leak containment reservoir pocket below a pipeline, or a valve or flange that is installed in the pipeline. The material is generally sized and shaped to cover the area below where the fluid leak occurs and extends to a sufficient area and height around the pipeline, valve and/or flange when installed, to provide a sufficient volume to contain any fluid leaked therefrom. The fluid containment reservoir further provides a sufficient open area, when installed, at the top of the containment reservoir to allow for maintenance or other work to be performed on the pipeline, valve and/or flange.

The invention is further directed to a method for capturing fluid leaks from a pipeline, or a valve or flange that is installed in the pipeline, wherein the leak capture device is installed below the area where the fluid leak occurs.

A further aspect of the invention is directed to a method for performing maintenance or other work on a pipeline, or a valve or flange that is installed in the pipeline, by installing the leak capture device below an area where a fluid leak may occur during such work to thereby capture any fluid leaks from the pipeline, valve, or flange.

### DETAILED DESCRIPTION

Although illustrative embodiments of one or more aspects of the invention are provided herein, the disclosed processes may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

In this disclosure, while compositions and methods or processes are often described in terms of “comprising” various components or steps, the compositions and methods may also “consist essentially of” or “consist of” the various components or steps, unless stated otherwise.

The terms “a,” “an,” and “the” are intended to include plural alternatives, e.g., at least one. For instance, the disclosure of “a fabric or sheet” or “a layer” is meant to encompass one, or a plurality of more than one, fabrics or sheets or layers, unless otherwise specified.

The term “and/or” is meant to include combinations of elements as well as the alternative inclusion of one or more elements. When multiple elements are recited, the term “and/or” is intended to mean that any combination is included, notwithstanding the fact that a specific combination may not be expressly mentioned.

All numerical values within the detailed description and the claims herein are modified by “about” or “approximately” the indicated value, and take into account experimental error and variations that would be expected by a person having ordinary skill in the art. The term “substantially” is also meant to allow for some flexibility in placement or amount, or other similar usage, and should be construed according to the reasonable expectations of the skilled artisan for the particular circumstance.

In one aspect, the present invention is a leak capture device, which is designed to be useful for capturing fluid leaks from a pipeline, valve and/or flange. The device is an uncomplicated but specifically tailored design based on a flexible, impermeable, fabric or sheet material, preferably a single piece or panel of continuous fabric or sheet material. The device is generally designed to be of a sufficient size and shape to contain any fluid that leaks or spills from a pipeline area, such as a valve or flange within the pipeline, when it is installed underneath where the fluid leak occurs. The material is also sized and shaped to extend beyond the immediate leak area and to provide a sufficient height when installed so that a fluid leak containment pocket is formed underneath the leak area. When installed, the containment reservoir provides an open area at the top of the reservoir so that the pipeline, valve or flange is accessible for maintenance, replacement of pipeline components, or other work.

The fabric or sheet material may comprise a single or multiple layers, and/or a coated layer, the material being selected from polymeric materials including thermoplastic, thermoset, rubber materials or a combination and/or composite thereof. While the material is preferably formed from a single continuous piece or panel, the layers may themselves be separate panels that are layered to form the material. The use of sections that are bonded, sewn, or otherwise attached to form the device is also possible, though generally not preferred since such areas may be susceptible to damage, ripping, or delamination. Nonwoven, woven, and reinforced fabrics and sheet materials may be used.

The device also includes supporting means so that the containment reservoir may be kept in place and the open top of the reservoir kept open. Any number and type of support may be used, including supports that are integral to the material, e.g., supports that are sewn in to the material, attached to or within the layers of the material, applied to the surface of the material or removably contained, such as in pockets, within or on the material. Supports that are external to the device and the material may also be used, e.g., to aid in keeping the reservoir in place. In some instances, straps may be conveniently used that may be attached to specific locations on the material or, as needed, to secure the device to one or more parts of a pipeline. Rigid supports may also be attached to or contained within pockets, or sewn into certain areas of the material, e.g., to help maintain an open top on the containment reservoir.

The device also generally comprises a centrally located section that forms the containment reservoir pocket and end sections on both ends of the centrally located section. When the device is installed below a pipeline, or a valve or flange that is installed in the pipeline, with the centrally located section installed to capture any leaks, the end sections may be wrapped around pipe sections on both sides of the area where the fluid leak occurs. Rigid rods, or other similar supporting means, may be used on the centrally located containment section of the device, to aid in keeping the top area of the reservoir open. Rods or other supports may be conveniently located along two parallel peripheral sides of the centrally located containment reservoir section such that, when installed below a pipeline, or a valve or flange that is installed in the pipeline, the rigid rod supports are substantially parallel to the pipeline. Supporting means such as one or more straps attached at one end to the device on both peripheral sides of the centrally located containment reservoir may also be used. When installed below a pipeline, or a valve or flange that is installed in the pipeline, such straps may be used to hold the containment reservoir in a secure position below the area where the fluid leak occurs.

Additional supports, such as rigid support rods, tubes, or bars, may be used to fixedly support and suspend the containment reservoir pocket below the area where the fluid leak occurs. In some instances, such supports may be conveniently laid across the top of the pipeline with straps that are attached to the containment reservoir used to support and suspend the containment reservoir below the pipeline in the area where the fluid leak occurs. The device may further comprise other components such as, without limitation, grounding adapters, drainage ports or valves, and the like.

As noted, the device may be used in a method for capturing fluid leaks from a pipeline, or a valve or flange that is installed in the pipeline. The device further provides for the convenient use during maintenance or other work on a pipeline, or a valve or flange that is installed in the pipeline since the work may be performed without removing the device. The method simply comprises the installation of the device below the area where the fluid leak occurs.

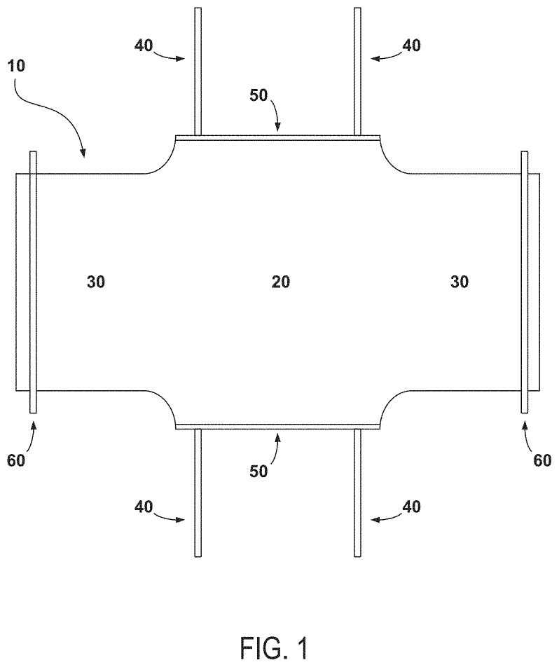

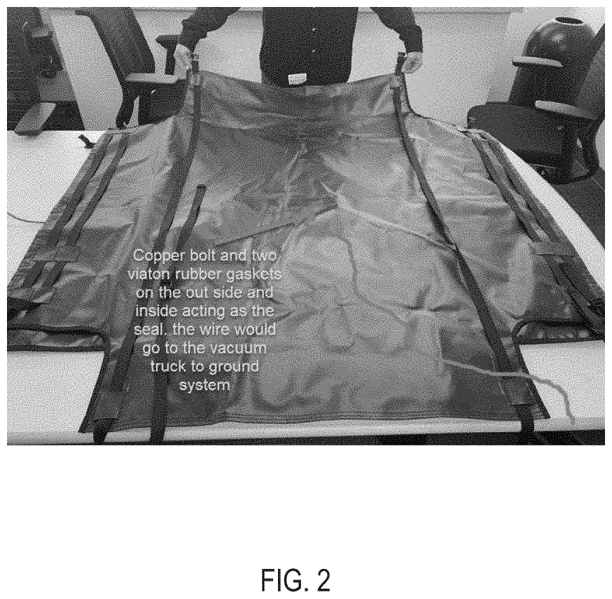

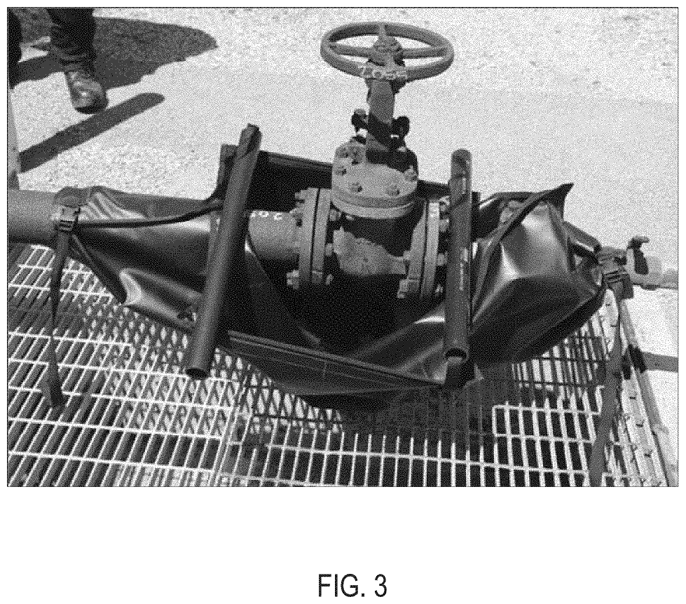

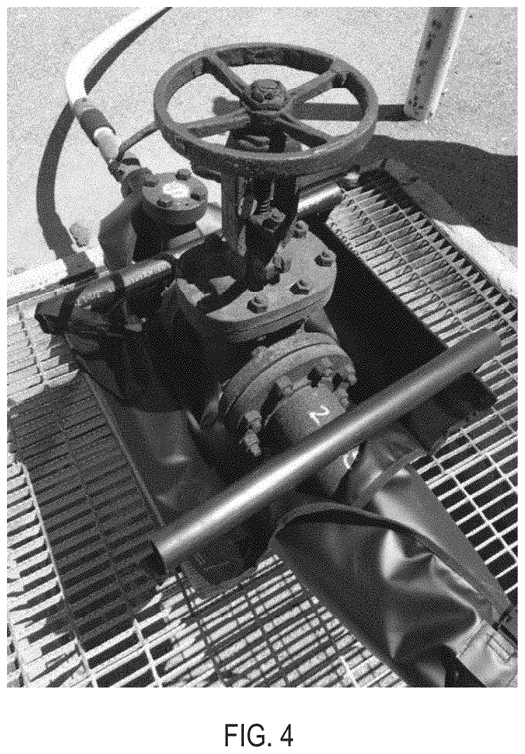

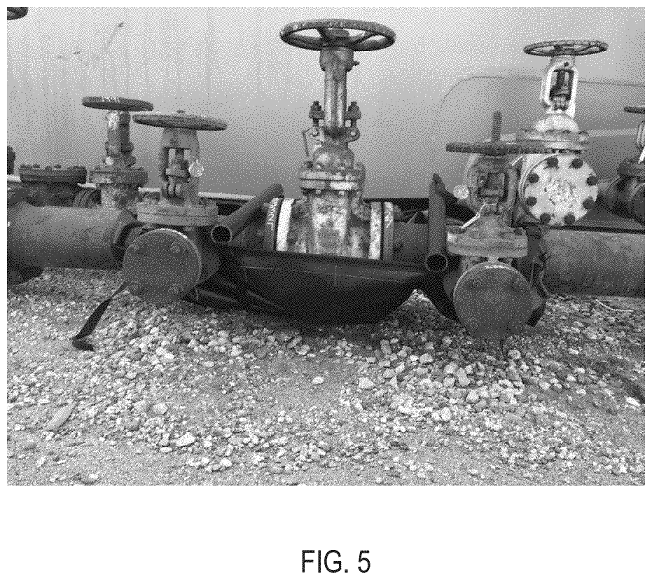

Illustrative embodiments are shown in FIGS. 1-5. In FIG. 1, a plan view of a fabric or sheet material 10 is shown, comprising centrally located section 20 and end wrapping sections 30. Straps 40 are shown as supports that are end attached to the centrally located containment reservoir section. Rigid supports 50 contained within sewn in areas along two peripheral sides of the central containment reservoir are also shown. End wrapping section 30 may also include straps 60 to aid in securing the end sections around two pipe sections on either side of a leak area. FIG. 2 show an image of the capture device laid out in an uninstalled view. FIGS. 3-5 show images of the device installed under an inline pipeline valve. In this embodiment and views, supporting tubes have been installed as supports above the pipeline to hold the containment reservoir in place using the straps attached to the central containment reservoir.

It will be understood that the invention is not limited to the embodiments described above and various modifications and improvements can be made without departing from the concepts described herein. Except where mutually exclusive, any of the features may be employed separately or in combination with any other features and the disclosure extends to and includes all combinations and sub-combinations of one or more features described herein.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

1. A leak capture device formed from a flexible fabric or sheet material, for use in capturing fluid leaks from a pipeline, valve and/or flange, wherein the device comprises
a flexible, impermeable, fabric or sheet material, having a sufficient size and shape, and comprising supporting means to form, when installed, a fluid leak containment reservoir pocket below a pipeline, or a valve or flange that is installed in the pipeline;
wherein, the material is sized and shaped to cover the area below where the fluid leak occurs and extends to a sufficient area and height around the pipeline, valve and/or flange when installed, to provide a sufficient volume to contain any fluid leaked therefrom; and
the fluid containment reservoir provides a sufficient open area, when installed, at the top of the containment reservoir to allow for maintenance or other work to be performed on the pipeline, valve and/or flange.

2. The device of claim 1, wherein the leak capture device is formed from a single panel of material and is substantially in accordance with FIGS. 1 and 2 when uninstalled.

3. The device of claim 1, wherein the leak capture device is formed from a single panel of material and is substantially in accordance with FIGS. 3-5 when installed below a valve to contain any fluid leak.

4. The device of claim 1, wherein the fabric or sheet material comprises a single or multiple layers, and/or a coated layer, the material being selected from polymeric materials including thermoplastic, thermoset, rubber materials or a combination and/or composite thereof.

5. The device of claim 1, wherein the supporting means are integral or external to the fabric or sheet material.

6. The device of claim 5, wherein the supporting means are integral to the fabric or sheet material and comprise rigid supports attached to or within the material, applied to a surface of the material, or removably contained within pockets formed within or on the material.

7. The device of claim 1, wherein the device comprises a centrally located section that forms the containment reservoir and end sections on both ends of the centrally located section when the device is installed below a pipeline, or a valve or flange that is installed in the pipeline, such that the end sections may be wrapped around pipe sections on both sides of the area where the fluid leak occurs.

8. The device of claim 7, wherein the supporting means comprise rigid rods that are located along two parallel peripheral sides of the centrally located containment reservoir such that, when installed below a pipeline, or a valve or flange that is installed in the pipeline, the rigid rods are substantially parallel to the pipeline.

9. The device of claim 8, wherein the supporting means comprises one or more straps attached at one end to the device on both peripheral sides of the centrally located containment reservoir, such that when installed below a pipeline, or a valve or flange that is installed in the pipeline, the straps may be used to hold the containment reservoir in a secure position below the area where the fluid leak occurs.

10. The device of claim 9, further comprising rigid support rods, tubes, or bars that in conjunction with the straps may be used to fixedly support and suspend the containment reservoir pocket below the area where the fluid leak occurs.

11. A method for capturing fluid leaks from a pipeline, or a valve or flange that is installed in the pipeline, the method comprising installing the device of claim 1 below the area where the fluid leak occurs.

12. A method for performing maintenance or other work on a pipeline, or a valve or flange that is installed in the pipeline, the method comprising capturing fluid leaks from the pipeline, valve, or flange according to the method of claim 11.
